(19) United States
(12) Patent Application Publication
(10) Pub. No.: US 2016/0086334 A1
(43) Pub. Date: Mar. 24, 2016

(54) A METHOD AND APPARATUS FOR ESTIMATING A POSE OF AN IMAGING DEVICE

(71) Applicant: Nokia Technologies Oy, Espoo (FI)

(72) Inventors: Lixin Fan, Tampere (FI); Youji Feng, Beijing (CN); Yihong Wu, Beijing (CN)

(21) Appl. No.: 14/778,048

(22) PCT Filed: Mar. 26, 2013
(86) PCT No.: PCT/CN2013/073225

§ 371 Date: Sep. 17, 2015

(51) Int. Cl. G06T 7/00; G06F 17/30; G06K 9/62; G06K 9/52

(52) U.S. Cl. CPC G06T 7/0042; G06K 9/52; G06F 17/30256; G06K 9/6202; G06T 2207/30244; G06T 2207/20076

(57) ABSTRACT

Embodiments relate to a method and a technical equipment for estimating a camera pose. The method comprises obtaining query binary feature descriptors for feature points in an image; placing a selected part of the obtained query binary feature descriptors into a query binary tree; and matching the query binary feature descriptors in the query binary tree to database binary feature descriptors of a database image to estimate a pose of a camera.

### TECHNICAL FIELD

The present application relates generally to a computer vision. In particular the present application relates to an estimation of a pose of an imaging device (later “camera”).

### BACKGROUND

Today, imaging devices are carried everywhere, because they are typically integrated in today's communication devices. Therefore also photos are captured of varying targets. When an image (i.e. a photo) is captured by a camera, the metadata about where the photo was taken is of great interest for many location based applications, e.g. navigation, augmented reality, virtual tourist guide, advertisements, games, etc.

Global positioning system and other sensor-based solutions provide rough estimation of the location of an imaging device. However, in this technical field, accurate three-dimensional (3D) camera position and orientation estimation are now in focus. The aim of the present application is to provide a solution for finding such accurate 3D camera position and orientation.

### SUMMARY

Various aspects of examples of the invention are set out in the claims.

According to a first aspect, a method comprises: obtaining query binary feature descriptors for feature points in an image; placing a selected part of the obtained query binary feature descriptors into a query binary tree; and matching the query binary feature descriptors in the query binary tree to database binary feature descriptors of a database image to estimate a pose of a camera.

According to a second aspect, an apparatus comprises at least one processor; and at least one memory including computer program code, the at least one memory and the computer program code configured to, with the at least one processor, cause the apparatus to perform at least the following: obtaining query binary feature descriptors for feature points in an image; placing a selected part of the obtained query binary feature descriptors into a binary tree; and matching the query binary feature descriptors in the binary tree to database binary feature descriptors of a database image to estimate a pose of a camera.

According to a third aspect, an apparatus, comprises at least: means for obtaining query binary feature descriptors for feature points in an image; means for placing a selected part of the obtained query binary feature descriptors into a binary tree; and means for matching the query binary feature descriptors in the binary tree to database binary feature descriptors of a database image to estimate a pose of a camera.

According to a fourth aspect, computer program comprises code for obtaining query binary feature descriptors for feature points in an image; code for placing a selected part of the obtained query binary feature descriptors into a query binary tree; and code for matching the query binary feature descriptors in the query binary tree to database binary feature descriptors of a database image to estimate a pose of a camera when the computer program is run on a processor.

According to a fifth aspect, a computer-readable medium encoded with instructions that, when executed by a computer, perform obtaining query binary feature descriptors for feature points in an image; placing a selected part of the obtained query binary feature descriptors into a query binary tree; and matching the query binary feature descriptors in the query binary tree to database binary feature descriptors of a database image to estimate a pose of a camera.

According to an embodiment a binary feature descriptor is obtained by a binary test on an area around a feature point.

According to an embodiment the binary test is

$$T τ ( f ) = \{ \begin{matrix}0 & I ( {x}_{1} , f ) < I ( {x}_{2} , f ) + θ t , \\ 1 & otherwise\end{matrix}$$

where I(x,f) is pixel intensity at a location with an offset x to the feature point f, and θ_{f} is a threshold.

According to an embodiment the database binary feature descriptors have been placed into a database binary tree with an identification.

According to an embodiment, related images are selected from the database images according to a probabilistic scoring method and ranking the selected images for matching purposes.

According to an embodiment, the matching further comprises searching among the database binary feature descriptors nearest neighbors for query binary feature descriptors.

According to an embodiment, a match is determined if the nearest neighbor distance ratio is below 0,7 between the nearest database binary feature descriptor and the query binary feature descriptor.

### BRIEF DESCRIPTION OF THE DRAWINGS

In the following, various embodiments are described in more detail with reference to the appended drawings, in which

FIG. 1 shows an embodiment of an apparatus;

FIG. 2 shows an embodiment of a layout of an apparatus;

FIG. 3 shows an embodiment of a system;

FIG. 4A shows an example of an online mode of the apparatus;

FIG. 4B shows an example of an offline mode of the apparatus;

FIG. 5 shows an embodiment of a method; and

FIG. 6 shows an embodiment of a method.

### DESCRIPTION OF EXAMPLE EMBODIMENTS

In the following, several embodiments are described in the context of camera pose estimation by means of a single photo and using a dataset of 3D points relating to the urban environment where the photo was taken.

Matching a photo to pictures in a dataset of urban environment pictures to find out accurate 3D camera position and orientation is very time consuming and thus challenging. By means of a present method time needed for matching can be reduced for large-scale urban scene datasets that have dozens of thousands of images.

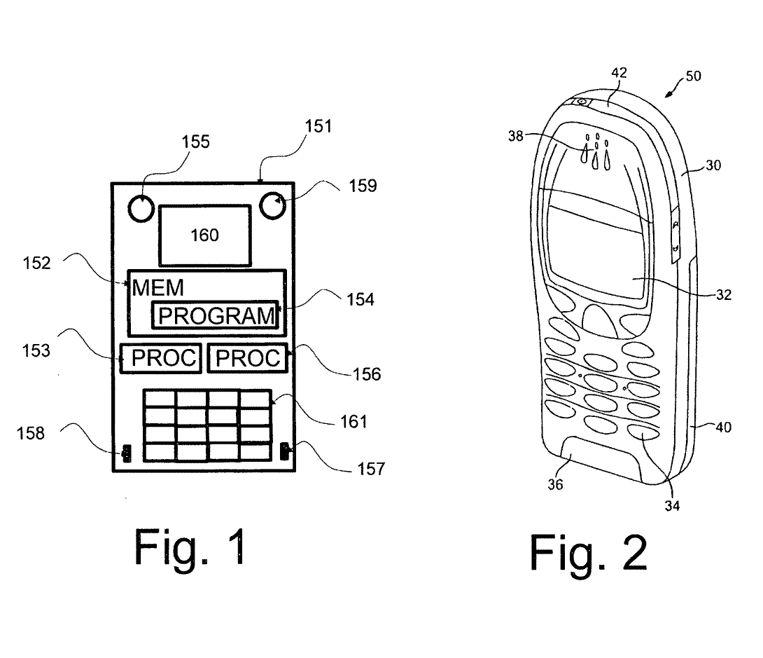

In this description term “pose” refers to an orientation and a position of an imaging device. The imaging device in this description is referred with term “camera” or “apparatus”, and it can be any communication device with imaging means or any imaging device, with communication means. The apparatus can be also traditional automatic or systems camera, or a mobile terminal with image capturing capability. Example of an apparatus is illustrated in FIG. 1.

### 1. An Embodiment of Technical Implementation

The apparatus 151 contains memory 152, at least one processor 153 and 156, and computer program code 154 residing in the memory 152. The apparatus according to the example of FIG. 1, also has one or more cameras 155 and 159 for capturing image data, for example stereo video. The apparatus may also contain one, two or more microphones 157 and 158 for capturing sound. The apparatus may also contain sensor for generating sensor data relating to the apparatus' relationship to the surroundings. The apparatus also comprises one or more displays 160 for viewing single-view, stereoscopic (2-view) or multiview (more-than-2-view) and/or previewing images. Anyone of the displays 160 may be extended at least partly on the back cover of the apparatus. The apparatus 151 also comprises an interface means (e.g. a user interface) which allows a user to interact with the apparatus. The user interface means is implemented either using one or more of the following: the display 160, a keypad 161, voice control, or other structures. The apparatus is configured to connect to another device e.g. by means of a communication block (not shown in FIG. 1) able to receive and/or transmit information.

FIG. 2 shows a layout of an apparatus according to an example embodiment. The apparatus 50 is for example a mobile terminal (e.g. mobile phone, a smart phone, a camera device, a tablet device) or other user equipment of a wireless communication system. Embodiments of the invention may be implemented within any electronic device or apparatus, such a personal computer and a laptop computer.

The apparatus 50 shown in FIG. 2 comprises a housing 30 for incorporating and protecting the apparatus. The apparatus 50 further comprises a display 32 in the form of e.g. a liquid crystal display. In other embodiments of the invention the display is any suitable display technology suitable to display an image or video. The apparatus 50 may further comprise a keypad 34 or other data input means. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 of FIG. 2 also comprises a battery 40 (or in other embodiments of the invention the device may be powered by any suitable mobile energy device such as solar cell, fuel cell or clockwork generator). The apparatus according to an embodiment may comprise an infrared port 42 for short range line of sight communication to other devices. In other embodiments the apparatus 50 may further comprise any suitable short range communication solution such as for example a Bluetooth wireless connection, Near Field Communication (NFC) connection or a USB/firewire wired connection.

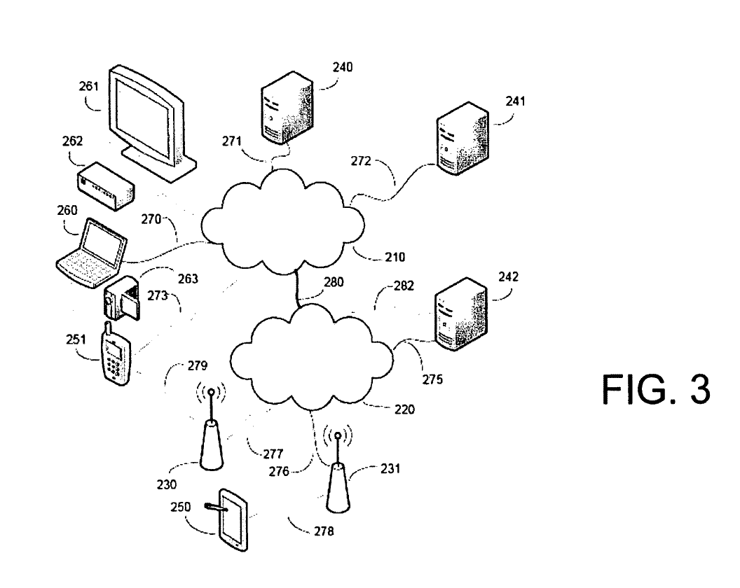

FIG. 3 shows an example of a system, where the apparatus is able to function. In FIG. 3, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 1 are shown servers 240, 241 and 242, each connected to the mobile network 220, which servers, or one of the servers, may be arranged to operate as computing nodes (i.e. to form a cluster of computing nodes or a so-called server farm) for a social networking service. Some of the above devices, for example the computers 240, 241, 242 may be such that they are arranged to make up a connection to the Internet with the communication elements residing in the fixed network 210.

There are also a number of end-user devices such as mobile phones and smart phones 251 for the purposes of the present embodiments, Internet access devices (Internet tablets) 250, personal computers 260 of various sizes and formats, and computing devices 261, 262 of various sizes and formats. These devices 250, 251, 260, 261, 262 and 263 can also be made of multiple parts. In this example, the various devices are connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection. All or some of these devices 250, 251, 260, 261, 262 and 263 are configured to access a server 240, 241, 242 and a social network service.

In the following “3D camera position and orientation” refers to 6-degree-of-freedom camera pose (6-DOF).

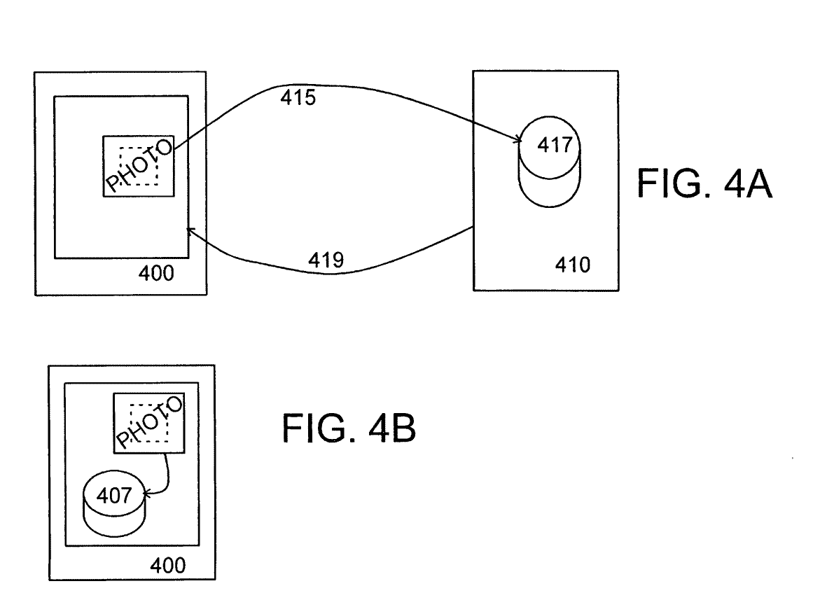

The method for recovering a 3D camera pose can be used in two modes: online mode and offline mode. Online mode, shown in FIG. 4A, in this description, refers to a mode, where the camera 400 uploads a photo to a server 410 through a communication network 415, and the photo is used to query the database 417 on the server. Accurate 3D camera pose is then recovered by the server 410 and returned 419 back to the camera to be used for different applications. The server 410 contains a database 417 covering urban environment of entire city.

Offline mode, shown in FIG. 4B, in this description, refers to mode, where the database 407 is already preloaded on the camera 400, and the query photo is matched against the database 407 on the camera 400. In such a case, the database 407 is smaller relative to the database 417 in the server 410. The camera pose recovery is carried out by the camera 400, typically having limited memory and computational power compared to the server. The solution may also be utilized together with known camera tracking methods. For example, when a camera tracker is lost, an embodiment for estimating the camera pose can be utilized to re-initialize the tracker. For example, if a continuity between camera positions is violated, due to e.g. fast camera motion, blur or occlusion, the camera pose estimation can be used to determine the camera position to start the tracking again.

For the purposes of the present application, term “photo” may also be used to refer to an image file containing visual content being captured of a scene. The photo is a still image or still shot (i.e. a frame) of a video stream.

### 2. An Embodiment of a Method

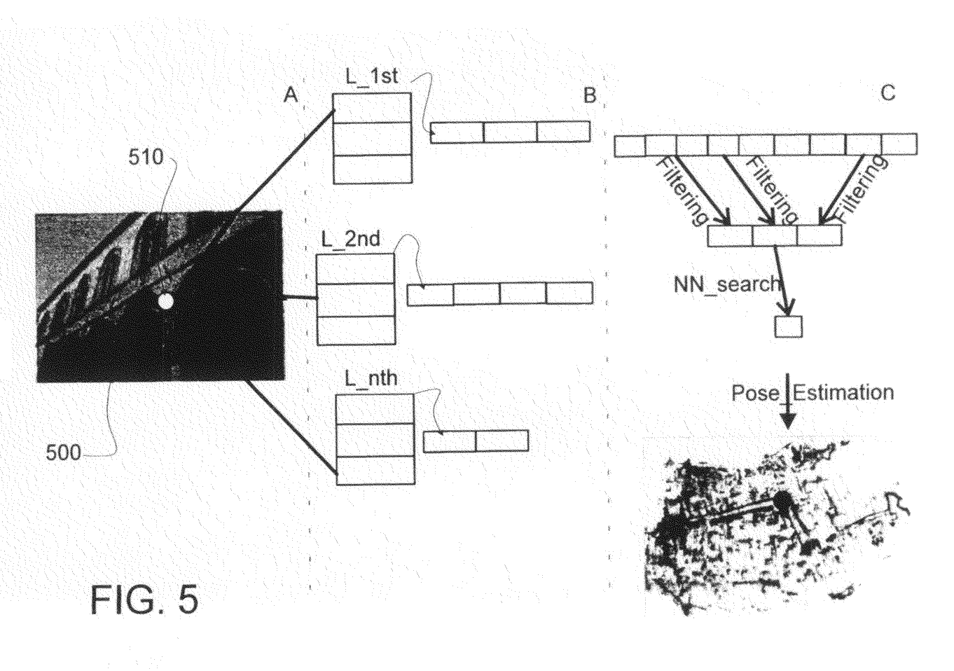

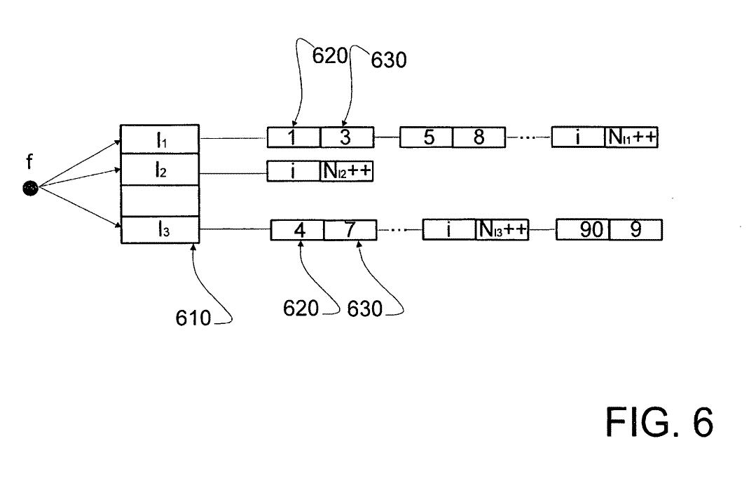

Both online and offline modes, fast matching of feature points with 3D data is used. FIG. 5 illustrates an example of a binary feature based matching method according to an embodiment. At first (FIG. 5: A), binary feature descriptors are obtained for feature points in an image—Then (FIG. 5: B) the obtained binary feature descriptors are assigned into a binary tree. At last (FIG. 5: C) the binary feature descriptors in the binary tree are matched to binary feature descriptors of a database image to estimate a pose of a camera.

In FIG. 5 a query image 500 having a feature point 510 is shown. From the query image 500, binary feature descriptors are obtained. Binary feature descriptor is a bit string that is obtained by a binary test on the patch around the feature point 510. Term “patch” is used to refer an area around a pixel. The pixel is the central pixel defined by its x and y coordinates and the patch typically includes all neighboring pixels. An appropriate size of the patch may also be defined for each feature point.

FIGS. 5 and 6 illustrate an embodiment of a method.

For database images, 3D points can be reconstructed from feature point tracks in the database images, by using structure from known motion approaches. At first, binary feature descriptors are extracted for the database feature points that are associated with the reconstructed 3D points. “Database feature points” are a subset of all features points that are extracted from database images. Those feature points that are unable to associate with any 3D points are not included as database feature points. Because each 3D point can be viewed from multiple images (viewpoints), there are often multiple image feature points (i.e. image patches) associated with the same 3D point.

It is possible to use 512 bits of the binary feature descriptors for the database feature points, however, in this embodiment 256 bits are used for reducing the dimensionality of the binary feature descriptors. The selection criterion is based on bitwise variance and pairwise correlations between selected bits. Using the selected 256 bits for descriptor extraction can not only save the memory, but also performs better than using the full 512 bits.

After this multiple randomized trees are trained to index substantially all database feature points. This is carried out according to a method disclosed under chapter 3 “Feature Indexing”.

After the training process, see FIG. 6, all the database features points {f} are stored in the leaf nodes and their identifications (later “IDs”) are stored in respective leaf nodes. At the same time, an inverted file of the database images is built for image retrieval according to a method disclosed in chapter 4 “Image retrieval”.

An embodiment of a method for database images was disclosed above. However, also an image that is obtained from the camera and used for camera pose estimation (referred as “query image”, is processed accordingly.

For the query image, a reduced binary feature descriptors for the feature points (FIG. 5: 510) in the query image 500 are extracted. “Query feature points” are a subset of all features points that are extracted from query image. The feature points of the query image are put to the leaves L_{—}1st-L_nth of the 1-n trees (FIG. 5). The feature points may be indexed by their binary form on the leaves of the tree. The trees may then be used to rank the database image according to a scoring strategy disclosed under chapter 4 “Image retrieval”.

The query feature points are matched against the database feature points in order to have a series of 2D-3D correspondences. FIG. 5 illustrates an example of the process of matching a single query feature point 510 with the database feature points. The camera pose of the query image is estimated through the resulted 2D-3D correspondences.

### 3. Feature Indexing

A set of the 3D database points is referred as P={pᵢ}. Each 3D point pᵢ in the database is associated with several feature points {fᵢ^{j}}, which forms a feature track in the reconstruction process. All these database feature points are indexed using randomized trees. Feature points are first dropped down the trees through the node tests and reach the leaves of the trees. The IDs of the features are then stored in the leaves. The test of each node is a simple binary test as

$$T τ ( f ) = \{ \begin{matrix}0 & I ( {x}_{1} , f ) < I ( {x}_{2} , f ) + θ t , \\ 1 & otherwise\end{matrix} \qquad ( Equation 1 )$$

where I(x,f) is the pixel intensity at the location with an offset x to the feature point f, and θₜ is a threshold. Before building the randomized trees, a set of tests are generated Γ={τ}={(x₁,x₂,θₜ)}. To train the trees, all the database feature points are taken as the training samples. The database feature points associated with the same 3D point belong to the same class. Given these training samples, each tree is generated from the root, which contains all the training samples, in the following steps.
1. For each node, the set of training samples S is partitioned into two subsets Sₜ and Sᵣ according to each test τ.

Sₜ={f|Tᵣ(f)=0}

Sᵣ={f|Tᵣ(f)=1}
2. The information gain of each partition is calculated as

$$Δ E = E ( S ) - ( \frac{\vert {S}_{l} \vert}{\vert S \vert} E ( {S}_{l} ) + \frac{\vert {S}_{r} \vert}{\vert S \vert} E ( {S}_{r} ) ) ,$$

where E(S) indicates the Shannon's entropy of S, and |S| indicates the number of samples in the S.
3. The partition of which the information gain is the largest is preserved, and the associated test τ is selected as the test of the node.
4. Repeat the above steps for the two child nodes till a preset depth is reached.

According to an embodiment, the number of trees is six and the depth of each tree is 20.

The embodiment continues by generating three thresholds (−20; 0; 20) and 512 location pairs from the short pairs of the binary feature descriptor pattern, hence obtaining 1536 tests in total. Then 50 out of the 512 location pairs is randomly chosen, and all three thresholds to generate 150 candidate tests of each node. It is noticed that the rotation and the scale of the location pairs are rectified using the scale and rotation information provided binary feature description.

### 4. Image Retrieval

Image retrieval is used to filter out descriptors extracted from unrelated images. This further accelerates the process of linear search. An image is considered as a bag of visual words, because the nodes of the randomize trees can be naturally treated as visual words. The randomized tree is used as a clustering tree to generate visual words for image retrieval. Instead of performing binary tests on feature descriptors, the binary tests are performed directly on the image patch. According to an embodiment, only the leaf nodes are treated as the visual words.

The database images may be ranked according to a probabilistic scoring strategy. Each database image is treated as a class, and C={cᵢ|i=1, . . . , N} represent the set of N classes.

As already described, for a query image, the feature points (f₁, . . . , f_{M}) are first dropped to the leaves, i.e. the words, {(l₁¹, . . . , l_{M}¹), . . . , (l₁^{K}, . . . , l_{M}^{K})} of the K trees.

Then the post probability P(c_{q}=cᵢ|{(l₁¹, . . . , l_{M}¹), . . . , (l₁^{K}, . . . , l_{M}^{K})}) of that the query image belongs to each class cᵢ is estimated as:

$$P ( {c}_{q} = {c}_{i} \vert \{ ( {l}_{1}^{1} , … , {l}_{M}^{1} ) , … , ( {l}_{1}^{K} , … , {l}_{M}^{K} ) \} ) = \frac{P ( \{ ( {l}_{1}^{1} , … , {l}_{M}^{1} ) , … , ( {l}_{1}^{K} , … , {l}_{M}^{K} ) \} ) \vert {c}_{q} = {c}_{i} ) P ( {c}_{q} = {c}_{i} )}{P ( \{ ( {l}_{1}^{1} , … , {l}_{M}^{1} ) , … , ( {l}_{1}^{K} , … , {l}_{M}^{K} ) \} )}$$

Since P(c_{q}=cᵢ) is assumed the same across all the classes, only the priori probability P({(l₁¹, . . . , l_{M}¹), . . . , (l₁^{K}, . . . , l_{M}^{K})})|c_{q}=cᵢ) need to be estimated. Under the assumption of that the trees are independent from each other and that the features are also independent from each other. The probability P({(l₁¹, . . . , l_{M}¹), . . . , (l₁^{K}, . . . , l_{M}^{K})})|c_{q}=cᵢ) can be further decomposed as

$$P ( \{ ( {l}_{1}^{1} , … , {l}_{M}^{1} ) , … , ( {l}_{1}^{K} , … , {l}_{M}^{K} ) \} ) \vert {c}_{q} = {c}_{i} ) = {\prod }_{k = 1}^{K} {\prod }_{m = 1}^{M} P ( {l}_{m}^{k} \vert {c}_{q} = {c}_{i} ) , where P ( {l}_{m}^{k} \vert {c}_{q} = {c}_{i} )$$

indicates the probability that a feature point in cᵢ is dropped to the leave lₘ^{k}.

In the process of feature indexing, an additional inverted file is built for the database images, i.e. {cᵢ}.

FIG. 6 shows how a feature point f contributes to the inverted file of the database images. All the warped patch around the feature point f are dropped to the leaves of each tree 610. Binary tests are somewhat sensitive to affine transformation. So for each feature point, 9 affine warped patches around the feature point f are generated. The 9 affine warped patches being generated are then dropped to the leaves of each tree 610. The frequencies 630 of these leaves in the image (620 refers to an image index), which contains the feature point, increase by one. An inverted file, P(lₘ^{k}|c_{q}=cᵢ) is simply estimated as

$$P ( {l}_{m}^{k} \vert {c}_{q} = {c}_{i} ) = \frac{{N}_{m}^{k}}{{N}_{i}}$$

where Nₘ^{k} is the frequency of the word lₘ^{k} occurring in image cᵢ, and N=Σₘ₌₁^{M}Nₘ^{k}Nᵢ is the total frequency of all the words occurring in the image cᵢ. To avoid the situation that P(lₘ^{k}|c_{q}=cᵢ) equals to 0, P(lₘ^{k}|c_{q}=cᵢ) is normalized as the form of

$$P ( {l}_{m}^{k} \vert {c}_{q} = {c}_{i} ) = \frac{{N}_{m}^{k} + λ}{{N}_{i} + {L}_{λ}}$$

where L is the number of leaves per tree and λ is a normalized term. In our implementation, λ is 0,1.

According to the estimated probabilities, the database images are ranked and used to filter (FIG. 5: Filtering) possible unrelated features in the process of next neighbor search.

Then the nearest neighbor of the query feature point is searched (FIG. 5: NN_search) among the database feature points, which are contained in these leaf nodes and extracted from the top n related images.

The extraction and processing of the binary feature descriptors are extremely efficient since only bitwise operations are involved.

### 5. Summary

A binary tree structure is used to index all database feature descriptors so that the matching between query feature descriptors and database descriptors is further accelerated. FIG. 5 illustrates an embodiment of a process for matching (A-C) a single query feature point 510 with the database feature points. First (FIG. 5: A), each query feature point (i.e. image patch) has to be tested with a series of binary tests (by Equation 1). Depending on outcomes of these binary tests (i.e. a string of “0” and “1”), the query image patch is then assigned to a leaf nodes of a randomized tree (L_{—}1st, L_{—}2 nd, L_nth) (FIG. 5: B). The query image patch is then matched with the database feature points that have already been assigned to the same leaf node (FIG. 5: C). There are multiple randomized trees used in the system, hence, there are multiple trees (L_{—}1st-L_nth) shown in FIG. 5. FIG. 5 does not illustrate the association of database feature points with certain leave nodes. Such off-line learning process is discussed in chapter “Feature indexing”. As a result of matching the query feature points against the database feature points, a series of 2D-3D correspondences are obtained. The camera pose of the query image is estimated through the resulted 2D-3D correspondences. When the correspondences between the query image feature points and 3D database point are obtained, the resulted matches are used to estimate the camera pose (FIG. 5: Pose_Estimation)

In the above, a binary feature-based localization method has been described. In the method, binary descriptors are employed to substitute histogram-based descriptors, which speedup the whole localization process. For fast binary descriptor matching, multiple randomized trees are trained to index feature points. Due to the simple binary tests in the nodes and a more even division of the feature space, the proposed indexing strategy is very efficient. To further accelerate the matching process, an image retrieval method can be used to filter out candidate features extracted from unrelated images. Experiments on city-scale databases show that the proposed localization method can achieve a high speed while keeping approximate performance. The present method can be used for near real time camera tracking in large urban environment. If parallel computing using multiple core is employed, real time performance is expected.

The various embodiments of the invention can be implemented with the help of computer program code that resides in a memory and causes the relevant apparatuses to carry out the invention. For example, an apparatus may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-24. (canceled)

25. A method, comprising:
obtaining query binary feature descriptors for feature points in an image;
placing a selected part of the obtained query binary feature descriptors into a query binary tree; and
matching the query binary feature descriptors in the query binary tree to database binary feature descriptors of a database image to estimate a pose of a camera.

26. The method according to claim 25, wherein
a binary feature descriptor is obtained by a binary test on an area around a feature point.

27. The method according to claim 26, wherein the binary test is
$$T τ ( f ) = \{ \begin{matrix}0 & I ( {x}_{1} , f ) < I ( {x}_{2} , f ) + {θ}_{t} , \\ 1 & otherwise ,\end{matrix}$$
where I(x,f) is pixel intensity at a location with an offset x to the feature point f, and θₜ is a threshold.

28. The method according to claim 25, wherein the database binary feature descriptors have been placed into a database binary tree with an identification.

29. The method according to claim 25, further comprising selecting related images from the database images according to a probabilistic scoring method and ranking the selected images for matching purposes.

30. The method according to claim 25, wherein the matching further comprises:
searching among the database binary feature descriptors nearest neighbors for query binary feature descriptors.

31. The method according to claim 30, further comprising:
determining a match, if the nearest neighbor distance ratio is below 0.7 between the nearest database binary feature descriptor and the query binary feature descriptor.

32. An apparatus, comprising:
at least one processor; and
at least one memory including computer program code
the at least one memory and the computer program code configured to, with the at least one processor, cause the apparatus to perform at least the following:
obtain query binary feature descriptors for feature points in an image;
place a selected part of the obtained query binary feature descriptors into a binary tree; and
match the query binary feature descriptors in the binary tree to database binary feature descriptors of a database image to estimate a pose of a camera.

33. The apparatus according to claim 32, wherein
a binary feature descriptor is obtained by a binary test on an area around a feature point.

34. The apparatus according to claim 33, wherein the binary test is
$$T τ ( f ) = \{ \begin{matrix}0 & I ( {x}_{1} , f ) < I ( {x}_{2} , f ) + {θ}_{t} , \\ 1 & otherwise ,\end{matrix}$$
where I(x,f) is pixel intensity at a location with an offset x to the feature point f, and θₜ is a threshold.

35. The apparatus according to claim 32, wherein the database binary feature descriptors have been placed into a database binary tree with an identification.

36. The apparatus according to claim 32, wherein, to match the query binary feature descriptors, the apparatus is further configured to select related images from the database images according to a probabilistic scoring method and ranking the selected images for matching purposes.

37. The apparatus according to claim 32, wherein, to match, the apparatus is further configured to:
search among the database binary feature descriptors nearest neighbors for query binary feature descriptors.

38. The apparatus according to claim 37, wherein the at least one memory and the computer program code configured to, with the at least one processor, cause the apparatus further to perform:
determine a match, if the nearest neighbor distance ratio is below 0.7 between the nearest database binary feature descriptor and the query binary feature descriptor.

39. A computer-readable medium encoded with instructions that, when executed by a computer, perform:
obtain query binary feature descriptors for feature points in an image;
place a selected part of the obtained query binary feature descriptors into a query binary tree; and
match the query binary feature descriptors in the query binary tree to database binary feature descriptors of a database image to estimate a pose of a camera.

40. The computer-readable medium according to claim 39, wherein a binary feature descriptor is obtained by a binary test on an area around a feature point.

41. The computer-readable medium according to claim 40, wherein the binary test is
$$T τ ( f ) = \{ \begin{matrix}0 & I ( {x}_{1} , f ) < I ( {x}_{2} , f ) + {θ}_{t} , \\ 1 & otherwise ,\end{matrix}$$
where I(x,f) is pixel intensity at a location with an offset x to the feature point f, and θₜ is a threshold.

42. The computer-readable medium according to claim 39, wherein the database binary feature descriptors have been placed into a database binary tree with an identification.

43. The computer-readable medium according to claim 39, further comprising instructions that, when executed by a computer, perform: select related images from the database images according to a probabilistic scoring method and ranking the selected images for matching purposes.

44. The computer-readable medium according to claim 39, further comprising instructions for matching that, when executed by a computer, perform:
search among the database binary feature descriptors nearest neighbors for query binary feature descriptors.
